(19) United States
(12) Patent Application Publication
(10) Pub. No.: US 2024/0299980 A1
(43) Pub. Date: Sep. 12, 2024

(54) BROADBAND ULTRASONIC TRANSDUCER

(71) Applicant: Infineon Technologies AG, Neubiberg (DE)

(72) Inventors: Erhard LANDGRAF, Dresden (DE); Sebastian PREGL, Dresden (DE); Fabian MERBELER, München (DE)

(21) Appl. No.: 18/591,858

(22) Filed: Feb. 29, 2024

(30) Foreign Application Priority Data
Mar. 7, 2023 (DE) 102023105648.4

(51) Int. Cl. B06B 1/06; B06B 1/02

(52) U.S. Cl. CPC B06B 1/06; B06B 1/0292

(57) ABSTRACT

An ultrasonic transducer includes an arrangement of ultrasonic transducer elements, wherein the ultrasonic transducer elements include a first ultrasonic transducer element and a second ultrasonic transducer element. The first ultrasonic transducer element has a first membrane having a first membrane reinforcement and a first membrane electrode, and a first counter-electrode. The second ultrasonic transducer element has a second membrane having a second membrane reinforcement and a second membrane electrode, and a second counter-electrode. Additionally, a resonant frequency of the first membrane differs from a resonant frequency of the second membrane.

### CROSS-REFERENCE TO RELATED APPLICATION

This application claims priority to German Patent Application No. 102023105648.4 filed on Mar. 7, 2023, the content of which is incorporated by reference herein in its entirety.

### TECHNICAL FIELD

The present disclosure relates to an ultrasonic transducer. A description is given in particular of concepts, processes and methods for the manufacture of ultrasonic transducers with a settable bandwidth.

### BACKGROUND

Phased-array ultrasound examinations with high requirements in terms of spatial resolution and allowable depth of penetration, such as for example in medical imaging, are increasingly using encoded signals such as for example frequency chirps, which in turn require a large bandwidth for the ultrasonic transducers used to transmit and receive acoustic signals.

### SUMMARY

Proceeding from this, the object of the present implementation is to provide an ultrasonic transducer that is distinguished by a high transmission and/or reception bandwidth.

This object has been achieved with the subject matter of the main claim. Advantageous implementations are specified in the dependent claims.

The implementation proposes an ultrasonic transducer that has an arrangement of ultrasonic transducer elements, wherein the ultrasonic transducer elements include a first ultrasonic transducer element and a second ultrasonic transducer element. The first ultrasonic transducer element has a first membrane having a first membrane reinforcement and a first membrane electrode and a first counter-electrode. The second ultrasonic transducer element has a second membrane having a second membrane reinforcement and a second membrane electrode and a second counter-electrode. A resonant frequency of the first membrane is different from the resonant frequency of the second membrane.

### BRIEF DESCRIPTION OF THE DRAWINGS

Possible implementations of the proposed ultrasonic transducer will now be explained in more detail with reference to the drawings. In the figures:

FIG. 1 shows a first semiconductor wafer;

FIG. 2 shows a second semiconductor wafer;

FIG. 3 shows a third semiconductor wafer;

FIG. 4 shows the processed semiconductor wafer according to FIG. 1;

FIG. 5 shows the processed semiconductor wafer according to FIG. 2;

FIG. 6 shows the processed semiconductor wafer according to FIG. 3;

FIG. 7 shows the processed semiconductor wafer according to FIG. 4;

FIG. 8 shows the processed semiconductor wafer according to FIG. 5;

FIG. 9 shows the processed semiconductor wafer according to FIG. 6;

FIG. 10 shows the processed semiconductor wafer according to FIG. 7;

FIG. 11 shows the processed semiconductor wafer according to FIG. 8;

FIG. 12 shows the processed semiconductor wafer according to FIG. 9;

FIG. 13 shows an example interconnection of ultrasonic transducer elements;

FIG. 14 shows an example interconnection of ultrasonic transducer elements;

FIG. 15 shows an example interconnection of ultrasonic transducer elements;

FIG. 16 shows an example interconnection of ultrasonic transducer elements; and

FIG. 17 shows a processed semiconductor wafer.

### DETAILED DESCRIPTION

Capacitive micromachined ultrasonic transducers (CMUTs), which are suitable for the conversion of high acoustic frequencies (over 10 MHz), are comparatively easy to manufacture. In particular, ultrasonic transducers may have a multiplicity of ultrasonic transducer elements that are able to be arranged in large arrays with a small footprint. The high process compatibility with the production of integrated circuits proves to be an additional advantage. Piezoelectric ultrasonic transducer elements manufactured in microsystems technology may be particularly suitable for low frequencies.

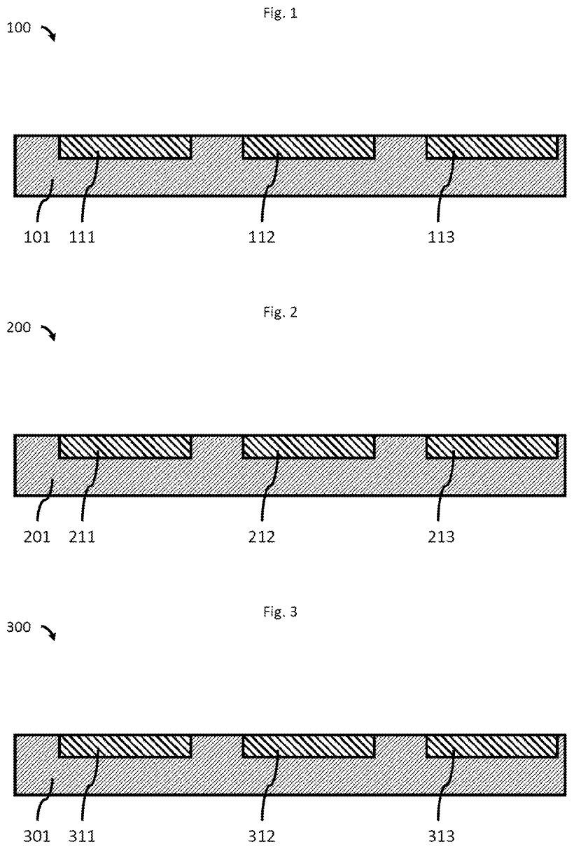

FIGS. 1 to 3 illustrate a first semiconductor wafer 100, a second semiconductor wafer 200 and a third semiconductor wafer 300, each having a semiconductor substrate 101, 201 and 301, respectively. The semiconductor substrate 101, 102, 103 may for example be a silicon substrate. Doped sections 111, 112, 113; 211, 212, 213; 311, 312, 313 are provided in the semiconductor substrate 101, 102, 103. The doped sections 111, 112, 113; 211, 212, 213; 311, 312, 313 may be generated by ion implantation.

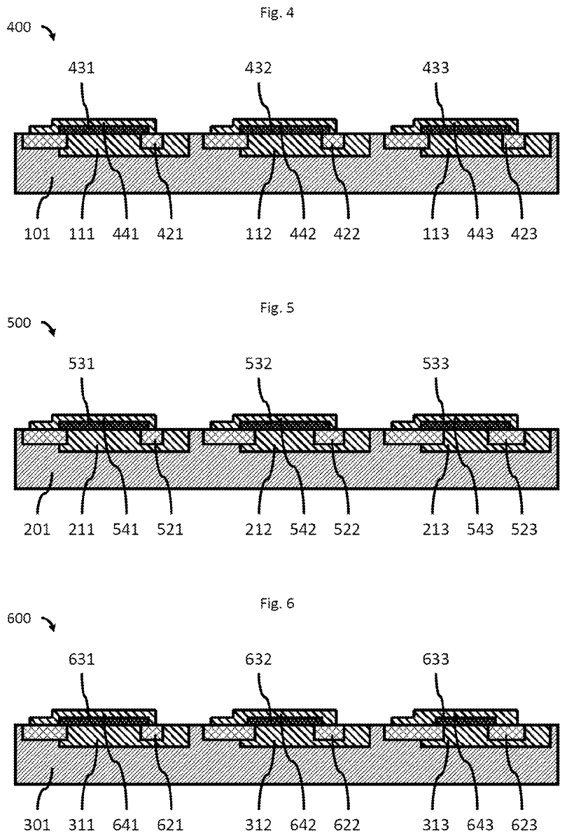

As illustrated in FIGS. 4 to 6, further shallow trench isolations (STI) 421, 422, 423; 521, 522, 523; 621, 622, 623 may be introduced in order to electrically isolate different regions of the semiconductor wafer 400, 500, 600 from one another.

In addition, respective sacrificial layers 431, 432, 433; 531, 532, 533; 631, 632, 633 are provided. The sacrificial layers 431, 432, 433; 531, 532, 533; 631, 632, 633 may be used to set the size of a membrane and/or the distance between two electrodes of an ultrasonic transducer element. The sacrificial layers 431, 432, 433; 531, 532, 533; 631, 632, 633 may be made of carbon. It is likewise conceivable to use sacrificial layers 431, 432, 433; 531, 532, 533; 631, 632, 633 that are made of a photoresist. Further implementations may make provision for the sacrificial layers to be made of an oxide or germanium. A respective layer 441, 442, 443; 541, 542, 543; 641, 642, 643 may be applied to the sacrificial layers 431, 432, 433; 531, 532, 533; 631, 632, 633 and may subsequently form part of a membrane of an ultrasonic transducer element to be produced. In particular, part of the layer 441, 442, 443; 541, 542, 543; 641, 642, 643 may subsequently form the membrane electrode. The layer 441, 442, 443; 541, 542, 543; 641, 642, 643 may be made of a doped semiconductor material and/or a metal and/or a metal alloy. The layer 441, 442, 443; 541, 542, 543; 641, 642, 643 may in particular be made of polysilicon.

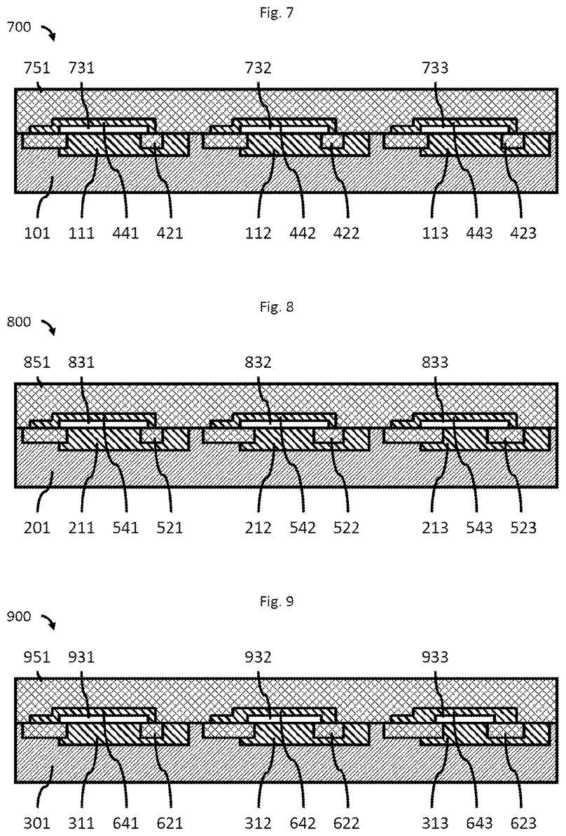

FIGS. 7 to 9 show the semiconductor wafers 700, 800, 900 after further production steps. The sacrificial layers 431, 432, 433; 531, 532, 533; 631, 632, 633 may for example have been removed by thermal decomposition, such that a cavity 731, 732, 733; 831, 832, 833; 931, 932, 933 is able to form in their place, which cavity is able to define the distance between the membrane electrode and the counter-electrode of the capacitive ultrasonic transducer elements to be produced. Further implementations may make provision for the sacrificial layers 431, 432, 433; 531, 532, 533; 631, 632, 633 to be removed by dry etching or wet chemical etching. In addition, a dielectric layer 751, 851, 951 is deposited on the layer 441, 442, 443; 541, 542, 543; 641, 642, 643. The dielectric layer 751, 851, 951 may for example be made of silicon oxide.

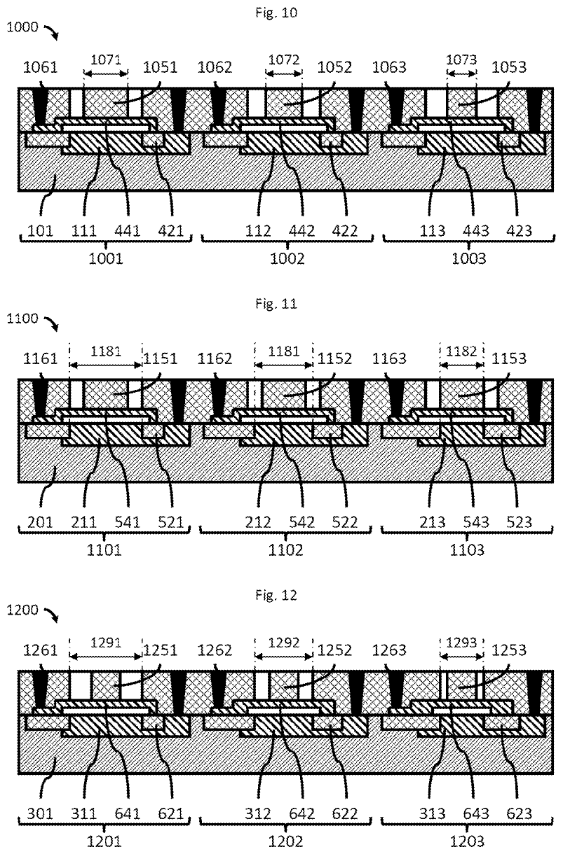

As illustrated with reference to the semiconductor wafers 1000, 1100, 1200 shown in FIGS. 10 to 12, the dielectric layer 751, 851, 951 of the semiconductor wafers 700, 800, 900, 900 may be structured for example with the aid of masks and etching, in order to form membrane reinforcements 1051, 1052, 1053; 1151, 1152, 1153; 1251, 1252, 1253. Provision is also made for vias 1061, 1062, 1063; 1161, 1162, 1163; 1261, 1262, 1263 in order to be able to apply a voltage between the membrane electrodes 441, 442, 443; 541, 542, 543; 641, 642, 643 and the counter-electrodes 111, 112, 113; 211, 212, 213; 311, 312, 313 or to read out the voltage.

FIG. 10 therefore illustrates an ultrasonic transducer 1000 that has an arrangement of capacitive ultrasonic transducer elements 1001, 1002, 1003. The capacitive ultrasonic transducer elements comprise a first ultrasonic transducer element 1001 and a second ultrasonic transducer element 1002. The first ultrasonic transducer element 1001 has a first membrane having a first membrane reinforcement 1051 and having a first membrane electrode 441 and a first counter-electrode 111. The second ultrasonic transducer element 1002 has a second membrane having a second membrane reinforcement 1052 and a second counter-electrode 112. A resonant frequency of the first membrane is different from the resonant frequency of the second membrane. In particular, a reference resonant frequency of the first membrane differs from a reference resonant frequency of the second membrane.

The first membrane and the second membrane may be circular and have the same diameter, as illustrated in FIG. 10. In principle, the first membrane and the second membrane may also be polygonal. The first membrane and the second membrane may then in particular have the same inner diameter and/or outer diameter. By way of example, the first membrane and the second membrane may be rectangular, in particular square. A respective membrane reinforcement 1051, 1052, 1053 is provided on the respective membrane of the ultrasonic transducer elements 1001, 1002, 1003. The membrane reinforcement 1051, 1052, 1053 may be configured as a circular cylinder materially bonded to the membrane (piston). Such a membrane reinforcement is able to increase the transducer efficiency. The circular cylinder diameter 1071 of the first membrane reinforcement 1051 may differ from the circular cylinder diameter 1072 of the second membrane reinforcement 1052. Changing the geometry and/or the dimensions of the membrane reinforcement makes it possible to adjust the resonant frequency of the respective ultrasonic transducer element. In particular, the three circular cylinder diameters 1071, 1072, 1073 may differ for this purpose.

FIG. 11 illustrates an ultrasonic transducer 1100 that has three different ultrasonic transducer elements 1101, 1102, 1103. The surface area of the counter-electrodes 211, 212, 213 of the ultrasonic transducer elements 1101, 1102, 1103 differs from one another. In particular, the diameter 1281, 1282, 1283 of the counter-electrodes 211, 212, 213 of the ultrasonic transducer elements 1101, 1102, 1103 may differ.

As illustrated in FIG. 12, not only the diameter of the counter-electrodes 311, 312, 313 but also the diameter 1291, 1292, 1293 of the membranes 641, 642, 643 of the ultrasonic transducer elements 1201, 1202, 1203 may differ.

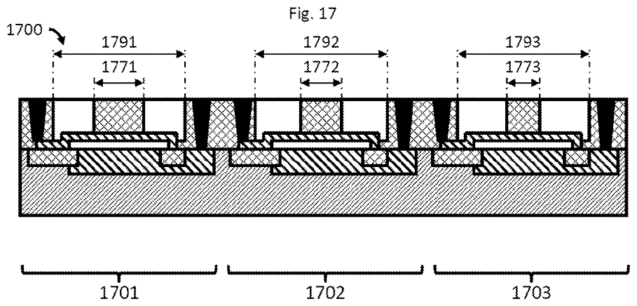

FIG. 17 illustrates another ultrasonic transducer 1700. The circular cylinder diameters 1771, 1772, 1773 of the ultrasonic transducer elements 1701, 1702, 1703 correspond here to those of the circular cylinder diameters 1071, 1072, 1073. To manufacture the circular cylinders with the circular cylinder diameters 1771, 1772, 1773, it is possible to etch out a region 1791, 1792, 1793 that is larger than the cavity under the membrane, which was produced for example by a carbon-based sacrificial layer. However, it is also conceivable for the etched-out region to be smaller than the cavity under the membrane, as illustrated in FIGS. 10 to 12.

Cut-out etching (for example by dry etching of silicon oxide) makes it possible to produce a region of larger diameter 1791, 1792, 1793.

While the bandwidth of conventional arrays of ultrasonic transducer elements, in which the individual ultrasonic transducer elements are copies of the same base cell having a particular cell design, is determined essentially by the bandwidth, in particular the resonant frequency, of the base cell, the proposed ultrasonic transducer having a multiplicity of ultrasonic transducer elements that have different resonant frequencies offers a larger bandwidth. In particular, the large number of individual resonant frequencies may merge into a resonance band in a damped scenario, for example when the ultrasonic transducer is in contact with a liquid or a gel. The article Bayram, Can, et al. “Bandwidth improvement in a cMUT array with mixed sized elements.” Proceedings-IEEE Ultrasonics Symposium. IEEE, 2005 has proposed, in ultrasonic transducer elements having a circular membrane, to vary the radius thereof, which made it possible to increase bandwidth by up to 155%.

Conventional CMUT ultrasonic transducer elements consist of a thin membrane that is coated with conductive electrode material so as to form a membrane electrode or forms the membrane electrode itself, which is separated from a counter-electrode by a gas-filled or evacuated gap. The membrane is supported at the edges and is deformed in the event of a pressure difference between the two sides of the membrane, for example in the event of an incident sound wave, thereby changing the capacitance of the capacitor formed by the membrane electrode and the counter-electrode. A pressure signal in the mechanical domain may thereby be converted into a capacitance signal in the electrical domain.

A variation in the membrane surface area, in particular in the radius of a circular membrane, of ultrasonic transducer elements of an ultrasonic transducer typically leads not only to a change in the resonant frequency of the respective membrane, but also to a different tightening torque. In implementations of the ultrasonic transducer, the electrode size may be adapted to the respective membrane in order to obtain similar pull-in voltages, such that the efficiency of the individual ultrasonic transducer elements is able to be increased.

The efficiency of the individual ultrasonic transducer elements may be further increased through the design of the membrane reinforcement of the individual membranes. The transducer efficiency, that is to say the capacitance change per pressure change (dC/dp), which is also called pressure sensitivity, may be achieved for example through a “piston” CMUT design, as described by Huang, Y., Zhuang, X., Haeggstrom, E. O., Ergun, A. S., Cheng, C. H., & Khuri-Yakub, B. T. (2009). Capacitive micromachined ultrasonic transducers with piston-shaped membranes: Fabrication and experimental characterization. IEEE transactions on ultrasonics, ferroelectrics, and frequency control, 56(1), 136-145. The deformable membrane may for example have a reinforcing element in the form of an uneven thickness, thereby preventing deformation in the thick membrane region (“piston”), typically in the membrane center. The elastic properties of the membrane may also be determined essentially by the thin membrane region between the carrier and the piston.

The mechanical properties of the membrane of piezoelectric ultrasonic transducer elements may be influenced in the same way.

The implementation proposes an ultrasonic transducer having a high bandwidth through the use of ultrasonic transducer elements having membranes with a different resonant frequency. The efficiency may be increased by membrane reinforcements, in particular pistons.

The use of membrane reinforcements increases degrees of freedom when setting the resonant frequency of the membranes of the individual ultrasonic transducer elements. By way of example, the mass and stiffness of the membrane change not only as a function of the cross-sectional surface area, but also in particular as a function of the height of the piston. This may make it possible to vary the resonant frequency of the individual membrane regardless of the electrode size and the footprint of the ultrasonic transducer element. In summary, it may be stated that there is a great deal of design leeway for ultrasonic elements and array designs in terms of adapting the frequency characteristics of the device to the requirements of the application.

The described ultrasonic transducers may be configured in particular to emit ultrasonic waves in a bandwidth of more than 4 MHz, in particular more than 6 MHz, in particular more than 10 MHz. In principle, however, the described concepts may also be used for ultrasonic transducers with lower bandwidths.

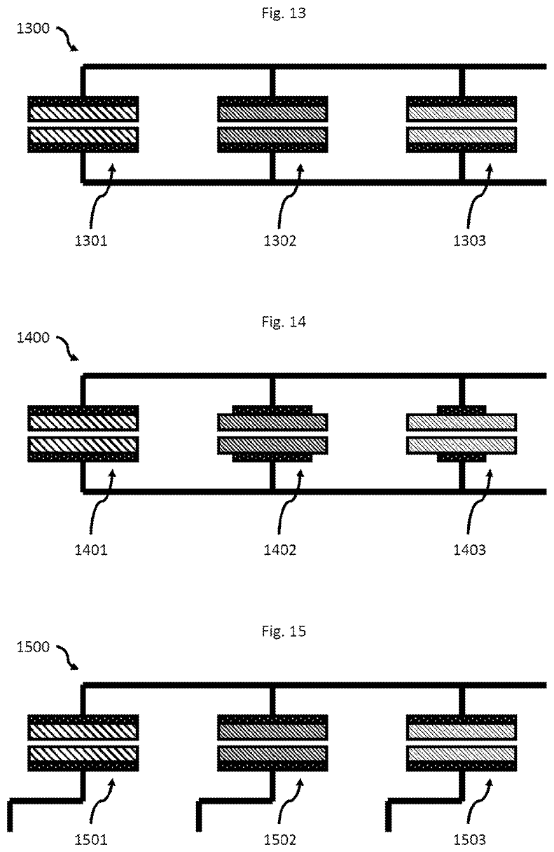

FIGS. 13 to 16 show various possible variants of the control of ultrasonic transducer elements of different ultrasonic transducers.

The ultrasonic transducer 1300 shown in FIG. 13 comprises three ultrasonic transducer elements 1301, 1302, 1303. The membranes of the ultrasonic transducer elements 1301, 1302, 1303 each have different resonant frequencies, as indicated by the different hatching. The ultrasonic transducer elements 1301, 1302, 1303 in this case have the same electrodes and are connected in parallel.

In the ultrasonic transducer 1400 illustrated in FIG. 14, the ultrasonic transducer elements 1401, 1402, 1403 are likewise connected in parallel. In contrast to the ultrasonic transducer 1300, in the ultrasonic transducer 1400, the electrodes of the ultrasonic transducer elements 1401, 1402, 1403 are adapted to the respective membrane of the ultrasonic transducer elements 1401, 1402, 1403, such that, even in the event of the same bias voltage, all of the ultrasonic transducer elements 1401, 1402, 1403 are able to be operated in the most optimum range possible.

FIG. 15 illustrates one example in which the ultrasonic transducer elements 1501, 1502, 1503 of the ultrasonic transducer 1500 are able to be controlled separately.

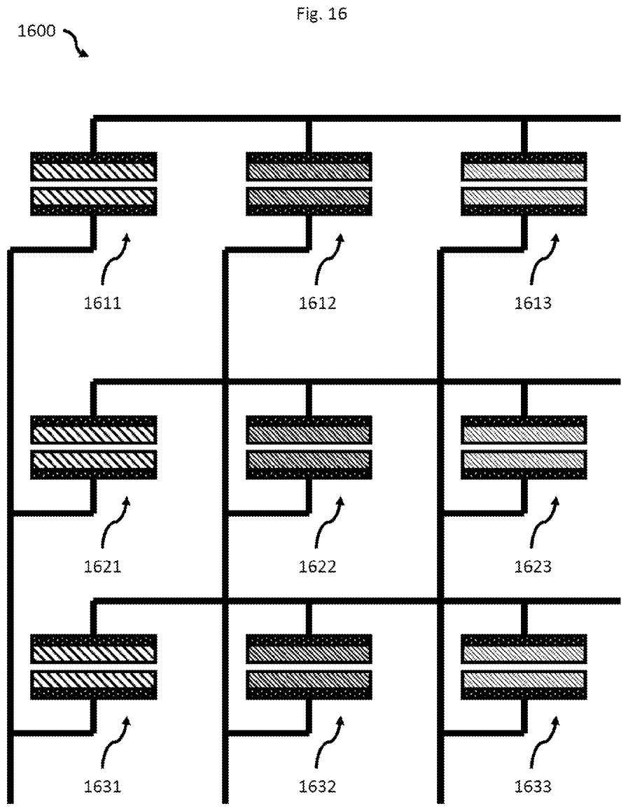

Finally, FIG. 16 shows one possible implementation of an ultrasonic transducer 1600 in the form of an array. Some of the electrodes of the ultrasonic transducer elements 1611, 1612, 1613; 1621, 1622, 1623 and 1631, 1632, 1633 each arranged in a row are each electrically connected to one another. Likewise, the other electrodes of the ultrasonic transducer elements 1611, 1621, 1631; 1612, 1622, 1623 and 1613, 1623, 1633 each arranged in a column are each electrically connected to one another. In this way, the ultrasonic transducer 1600 may be controlled or read out in the form of a matrix.

### ASPECTS

A few aspect implementations are defined through the following aspects:

Aspect 1. Ultrasonic transducer, having an arrangement of ultrasonic transducer elements, wherein the ultrasonic transducer elements comprise a first ultrasonic transducer element and a second ultrasonic transducer element, wherein the first ultrasonic transducer element has a first membrane having a first membrane reinforcement and a first membrane electrode; and a first counter-electrode, wherein the second ultrasonic transducer element has a second membrane having a second membrane reinforcement and a second membrane electrode; and a second counter-electrode, wherein a resonant frequency of the first membrane differs from a resonant frequency of the second membrane.

Aspect 2. Ultrasonic transducer according to aspect 1, wherein the first membrane is circular or polygonal, and wherein the second membrane is circular or polygonal.

Aspect 3. Ultrasonic transducer according to aspect 1, wherein the first membrane has a first diameter, wherein the second membrane has a second diameter, wherein the first diameter is equal to or not equal to the second diameter.

Aspect 4. Ultrasonic transducer according to one of aspects 1 to 3, wherein the first membrane and the second membrane are of the same thickness.

Aspect 5. Ultrasonic transducer according to one of aspects 1 to 4, wherein the first membrane reinforcement and/or the second membrane reinforcement are arranged on a side opposite the first counter-electrode or the second counter-electrode, in particular centrally on the first membrane or second membrane.

Aspect 6. Ultrasonic transducer according to one of aspects 1 to 5, wherein the first membrane reinforcement and/or the second membrane reinforcement are formed as cylinders, in particular circular cylinders, that are materially bonded to the first membrane, respectively second membrane.

Aspect 7. Ultrasonic transducer according to aspect 6, wherein a first circular cylinder diameter of the first membrane reinforcement differs from a second circular cylinder diameter of the second membrane reinforcement.

Aspect 8. Ultrasonic transducer according to one of aspects 1 to 7, wherein the first membrane electrode is electrically conductively connected to the second membrane electrode, and/or wherein the first counter-electrode is electrically conductively connected to the second membrane electrode.

Aspect 9. Ultrasonic transducer according to one of aspects 1 to 8, wherein the surface area of the first membrane electrode differs from the surface area of the second membrane electrode and/or the surface area of the first counter-electrode differs from the surface area of the second counter-electrode.

Aspect 10. Ultrasonic transducer according to one of aspects 1 to 9, wherein the ultrasonic transducer elements comprise a capacitive ultrasonic transducer element.

Aspect 11. Ultrasonic transducer according to one of aspects 1 to 10, wherein the ultrasonic transducer elements comprise a piezoelectric ultrasonic transducer element.

Aspect 12. Ultrasonic transducer according to one of aspects 1 to 11, wherein the arrangement of capacitive ultrasonic transducer elements comprises a first group of ultrasonic transducer elements and a second group of ultrasonic transducer elements, wherein the first group comprises the first ultrasonic transducer element and the second ultrasonic transducer element, wherein the second group comprises a third ultrasonic transducer element and a fourth ultrasonic transducer element, wherein the third ultrasonic transducer element corresponds to the first ultrasonic transducer element, and wherein the fourth ultrasonic transducer element corresponds to the second ultrasonic transducer element.

Aspect 13. Ultrasonic transducer according to one of aspects 1 to 12, wherein the first membrane electrode is electrically connected to the second membrane electrode, wherein a third membrane electrode of the third ultrasonic transducer element is electrically connected to a fourth membrane electrode of the fourth ultrasonic transducer element, wherein the first counter-electrode is electrically connected to a third counter-electrode of the third ultrasonic transducer element, wherein the second counter-electrode is electrically connected to a fourth counter-electrode of the fourth ultrasonic transducer element.

Aspect 14. Ultrasonic transducer according to one of aspects 1 to 13, wherein the first counter-electrode is electrically connected to the second counter-electrode, wherein a third counter-electrode of the third ultrasonic transducer element is electrically connected to a fourth counter-electrode of the fourth ultrasonic transducer element, wherein the first membrane electrode is electrically connected to a third membrane electrode of the third ultrasonic transducer element, wherein the second membrane electrode is electrically connected to a fourth membrane electrode of the fourth ultrasonic transducer element.

Aspect 15. Ultrasonic transducer according to one of aspects 1 to 14, wherein the ultrasonic transducer is configured to emit ultrasonic waves in a bandwidth of more than 4 MHz, in particular more than 6 MHz, in particular more than 10 MHz.

Although specific aspect implementations have been illustrated and described in this description, those skilled in the art will recognize that a multiplicity of alternative and/or equivalent implementations may be selected as a substitute for the specific aspect implementations that are disclosed and described in this description, without departing from the scope of the disclosed implementation. This application is intended to cover all adaptations or variations of the specific aspect implementations that are discussed here. It is therefore intended for this implementation to be restricted only by the claims and the equivalents of the claims.

1. An ultrasonic transducer, comprising:
an arrangement of ultrasonic transducer elements, wherein the arrangement of ultrasonic transducer elements comprises a first ultrasonic transducer element and a second ultrasonic transducer element,
wherein the first ultrasonic transducer element includes:
a first membrane having a first membrane reinforcement and a first membrane electrode; and
a first counter-electrode,
wherein the second ultrasonic transducer element includes:
a second membrane having a second membrane reinforcement and a second membrane electrode, and
a second counter-electrode, and
wherein a resonant frequency of the first membrane differs from a resonant frequency of the second membrane.

2. The ultrasonic transducer as claimed in claim 1, wherein the first membrane is circular or polygonal, and
wherein the second membrane is circular or polygonal.

3. The ultrasonic transducer as claimed in claim 1, wherein the first membrane has a first diameter,
wherein the second membrane has a second diameter, and
wherein the first diameter is equal to or not equal to the second diameter.

4. The ultrasonic transducer as claimed in claim 1, wherein the first membrane and the second membrane have a same thickness.

5. The ultrasonic transducer as claimed in claim 1, wherein at least one of the first membrane reinforcement or the second membrane reinforcement is arranged on a side opposite the first counter-electrode or the second counter-electrode, respectively.

6. The ultrasonic transducer as claimed in claim 1, wherein at least one of the first membrane reinforcement or the second membrane reinforcement is formed as a cylinder.

7. The ultrasonic transducer as claimed in claim 6, wherein a first circular cylinder diameter of the first membrane reinforcement differs from a second circular cylinder diameter of the second membrane reinforcement.

8. The ultrasonic transducer as claimed in claim 1, wherein the first membrane electrode is electrically conductively connected to the second membrane electrode.

9. The ultrasonic transducer as claimed in claim 1, wherein a surface area of the first membrane electrode differs from a surface area of the second membrane electrode.

10. The ultrasonic transducer as claimed in claim 1, wherein the arrangement of ultrasonic transducer elements comprises at least one capacitive ultrasonic transducer element.

11. The ultrasonic transducer as claimed in claim 1, wherein the arrangement of ultrasonic transducer elements comprises at least one piezoelectric ultrasonic transducer element.

12. The ultrasonic transducer as claimed in claim 1, wherein the arrangement of ultrasonic transducer elements comprises a first group of ultrasonic transducer elements and a second group of ultrasonic transducer elements,
wherein the first group of ultrasonic transducer elements comprises the first ultrasonic transducer element and the second ultrasonic transducer element,
wherein the second group of ultrasonic transducer elements comprises a third ultrasonic transducer element and a fourth ultrasonic transducer element,
wherein the third ultrasonic transducer element corresponds to the first ultrasonic transducer element, and
wherein the fourth ultrasonic transducer element corresponds to the second ultrasonic transducer element.

13. The ultrasonic transducer as claimed in claim 12, wherein the first membrane electrode is electrically connected to the second membrane electrode,
wherein a third membrane electrode of the third ultrasonic transducer element is electrically connected to a fourth membrane electrode of the fourth ultrasonic transducer element,
wherein the first counter-electrode is electrically connected to a third counter-electrode of the third ultrasonic transducer element, and
wherein the second counter-electrode is electrically connected to a fourth counter-electrode of the fourth ultrasonic transducer element.

14. The ultrasonic transducer as claimed in claim 12, wherein the first counter-electrode is electrically connected to the second counter-electrode,
wherein a third counter-electrode of the third ultrasonic transducer element is electrically connected to a fourth counter-electrode of the fourth ultrasonic transducer element,
wherein the first membrane electrode is electrically connected to a third membrane electrode of the third ultrasonic transducer element, and
wherein the second membrane electrode is electrically connected to a fourth membrane electrode of the fourth ultrasonic transducer element.

15. The ultrasonic transducer as claimed in claim 1, wherein each ultrasonic transducer of the arrangement of ultrasonic transducer elements is configured to emit ultrasonic waves in a bandwidth of more than 4 MHz.

16. The ultrasonic transducer as claimed in claim 5, wherein the first membrane reinforcement is arranged centrally on the first membrane, and wherein the second membrane reinforcement is arranged centrally on the second membrane.

17. The ultrasonic transducer as claimed in claim 6, wherein the first membrane reinforcement is formed as circular cylinder that is materially bonded to the first membrane, and wherein the second membrane reinforcement is formed as circular cylinder that is materially bonded to the second membrane.

18. The ultrasonic transducer as claimed in claim 8, wherein the first counter-electrode is electrically conductively connected to the second membrane electrode.

19. The ultrasonic transducer as claimed in claim 1, wherein the first counter-electrode is electrically conductively connected to the second membrane electrode.

20. The ultrasonic transducer as claimed in claim 9, wherein a surface area of the first counter-electrode differs from a surface area of the second counter-electrode.

21. The ultrasonic transducer as claimed in claim 1, wherein a surface area of the first counter-electrode differs from a surface area of the second counter-electrode.
